(19) United States
(12) Patent Application Publication
(10) Pub. No.: US 2013/0335195 A1
(43) Pub. Date: Dec. 19, 2013

(54) Source and Destination Lighted Indicator for Medical Fluid Lines

(71) Applicant: Bobby E. Rogers, San Diego, CA (US)

(72) Inventor: Bobby E. Rogers, San Diego, CA (US)

(21) Appl. No.: 13/921,154

(22) Filed: Jun. 18, 2013

Related U.S. Application Data
(60) Provisional application No. 61/661,310, filed on Jun. 18, 2012.

(51) Int. Cl. G08B 5/36

(52) U.S. Cl. CPC G08B 5/36
USPC 340/6.1

(57) ABSTRACT

A identification system for hospital fluid lines and the like. The identification system includes a source identifier and a destination identifier, each having a light, a control button for controlling the light, a transmitter for transmitting a control signal from the control button, and a transmission medium for conveying the transmitted control signal to the other of the source identifier or destination identifier.

### CROSS REFERENCE TO RELATED APPLICATION

This application claims priority under 35 U.S.C. §119(e) to U.S. Provisional Patent Application Ser. No. 61/661,310, filed Jun. 18, 2012 and entitled “Source and Destination Lighted Indicator for Medical Fluid Lines”, the disclosure of which identified in this paragraph is incorporated by reference herein in its entirety.

### BACKGROUND

As shown in FIG. 1, in hospitals and other clinical settings, there can be an array of equipment, such as medication pumps, and fluid lines from the equipment, around a patient. In any number, these fluid lines will inevitably twist together and become tangled. At best, continuous untangling of these fluid lines by medical staff steals attention and leads to lower productivity and loss of valuable time. Worse, the medical staff typically needs to spend large amounts of time to determine the source and/or destination of a fluid line, which, if not done accurately, could result in a serious or life-threatening medication error.

Several attempts to address these problems include providing a common pump platform, such as an intravenous (IV) pole. Such platforms can host a large number of pumps in an organized array, and may even include a number to identify each pump. However, having such large number of pumps so close together exacerbates the tendency of the fluid lines to become twisted. Another attempted solution includes providing a color to an end of a fluid line, and a corresponding color at either the pump or the other end of the fluid line. Yet, the setting in which fluid lines is used typically has poor lighting, making the colored ends less visible. Further, there is a natural limit to the number of optically distinguishable colors that can be used, and which can lead to inventory problems based on how often each line is changed.

What is needed is an effective way of identifying the ends of a line in a medical setting.

### SUMMARY

In one aspect, an identification system is described. The identification system includes a source identifier and a destination identifier, each having a light, a control button for controlling the light, a transmitter for transmitting a control signal from the control button, and a transmission medium for conveying the transmitted control signal to the other of the source identifier or destination identifier.

In another aspect, an identification method includes the steps of attaching proximate to each end of a fluid line an identifier, each identifier having a light, a control button for controlling the light, a transmitter for transmitting a control signal from the control button, and a transmission medium for conveying the transmitted control signal from one identifier to the other identifier. The method further includes controlling the button on one identifier to generate the control signal to activate an associated light, and transmitting the control signal to activate a corresponding light on the other identifier.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a hospital environment.

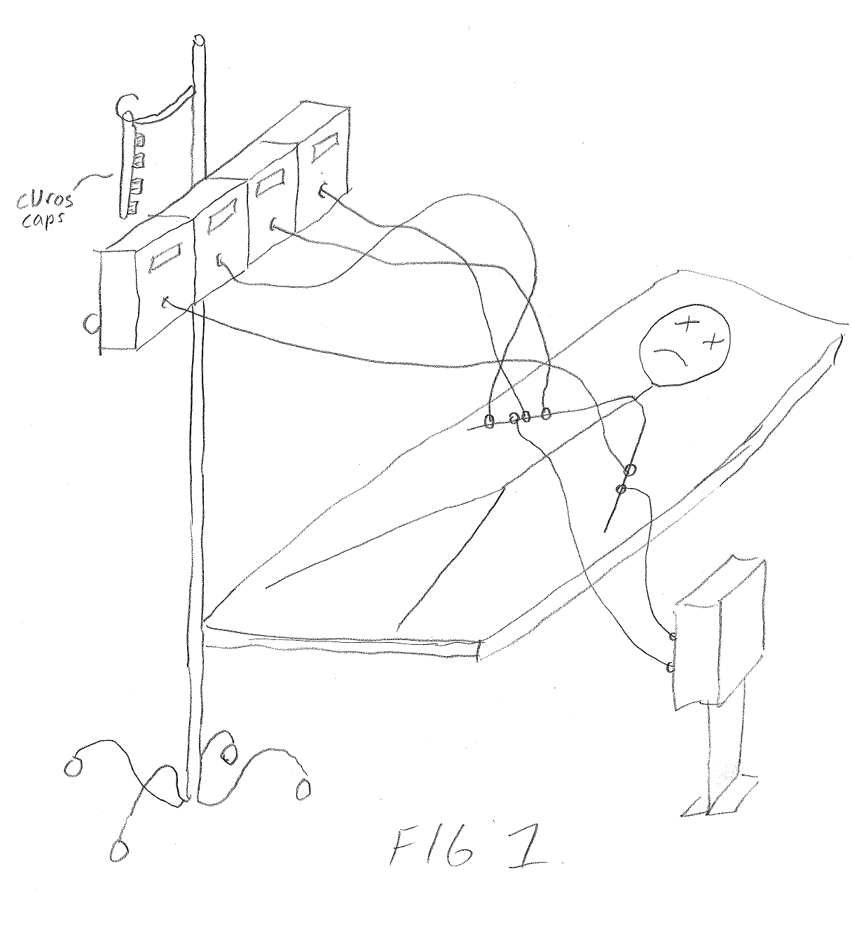

FIG. 2 illustrates one implementation of a lighted indicator for identifying source and destination of a fluid line.

FIG. 3 illustrates another implementation of a lighted indicator for identifying source and destination of a fluid line.

Like reference symbols in the various drawings indicate like elements.

### DETAILED DESCRIPTION

This document describes a system and method for identifying ends of a fluid line, such as an IV line or other medicine-providing line. Identification can occur from either the destination end (i.e. near ‘the distal end, which is connected to the patient either directly or indirectly) of the line, or from the source end (i.e. near the proximal end, which is connected to a fluid pump or other equipment), or both in coordination.

In most implementations, a lighted indicator is provided for identifying either a proximal or distal end of a fluid line, or both, in proximity to an event by a user for seeking the identifying. In some implementations, the lighted indicator can include, at each of the proximal and distal ends, a light source, an energy source, a controller, and a communication medium between the controllers of the proximal and distal ends. The communication medium can include an input device, a transmission device operated by the input device for producing a signal, and a transmission medium for carrying and transmitting the signal produced by the transmission device. The signal can operated the controller to control the energy source and operated the light source of the corresponding lighted indicator, i.e. operation of one lighted indicator can operate that or another lighted indicator.

In most implementations, the lighted indicator includes a pair of lighted indicators, each of which can be controlled locally as well as control the paired lighted indicator.

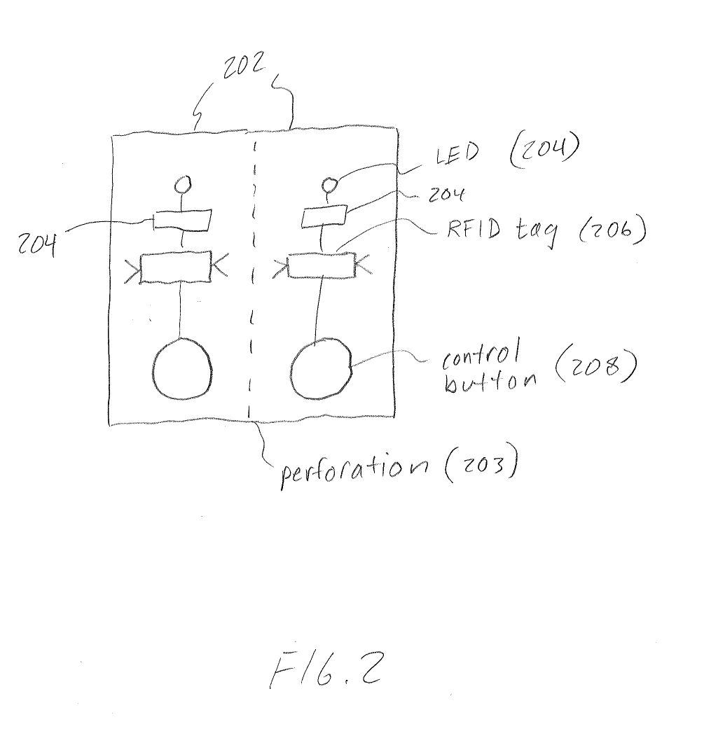

In some implementations, an identification system is illustrated in FIG. 2. The identification system includes a set of tapes 202, such as two pieces of tape, which can be initially connected but separable, i.e. by perforations 203 or the like. Each section or piece of tape 202 includes a light emitting diode (LED) 204 as light source, a battery 204 as an energy source, and a radio frequency identifier (RFID) tag 206 and associated radio frequency transmission path as a communication medium. The LED and the signal transmission by the RFID tag each can be controlled by a button 208, which can be a mere contact point or ON/OFF switch. If the button 208 is activated, the LED lights on, and the RFID tag will transmit a signal with a unique identifier to another, pre-identified piece of tape to enable its own LED to illuminate.

One piece of the tape can be placed on or near the distal end of a line (or other elongated structure or object), while a corresponding other piece of the tape can be placed on or near the proximal end of the line, or on the device to which the line is attached. Accordingly, operation of either piece of tape will illuminate the other or both LEDs 204, and will provide an efficient indicator for identifying the source and destination of any line or other elongated object to which the pair of identifiers are attached.

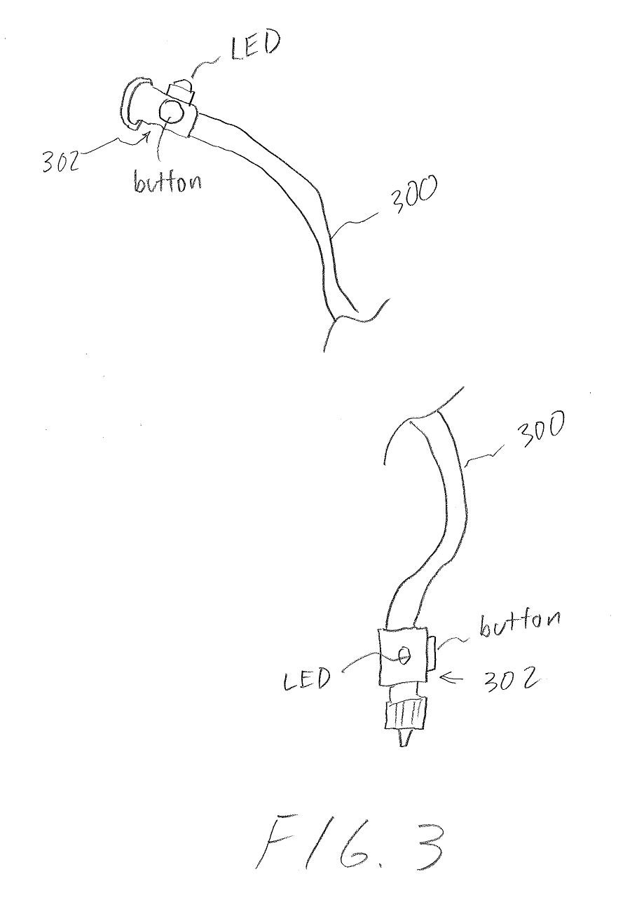

FIG. 3 shows an implementation in which a lighted indicator 302 can be integrated with both proximal and distal ends of a fluid line 300, either by a removable module or integrated into end interfaces of the line. In the case of a modular implementation, where a removable end cuff or cap can include an LED, a control button, a transmitter, and a wireless or wired communication medium, the lighted indicator can be reused on other lines when necessary.

Where the source indicator is connected with the proximal end of the line, i.e. the end of the line which connects to the pump, the source indicator can be embedded within the construct of the pump itself. This allows the source indicator to use the pump's identifier information or other electronic record information that might be accessed and/or accumulated for patient care. Further, the source indicator and/or destination indicator could utilize the pump's power source for powering the LED and other components. Further still, the lighted indicator could have its own unique identifier, such as a code transmitted by RFID, and power source, such as a battery.

In yet another implementation, the destination indicator could be embedded within the material of the tubing or fluid line of interest. Pairing with a source indicator can occur prior to, or concurrent with, install or use with a patient. Communication of signals between the source and destination indicators can be wireless or by a wire embedded within or laid on the cladding of the line, for example.

The LEDs can be controlled to be illuminated for a period of time as a steady light, or can be modulated to blink or illuminate a sequence of blinks and steady illumination, in any combination. The blinking sequence can be programmed to correspond with a priority scheme; for instance, a rapid blinking can indicate a critical line, while a steady light can indicate a less critical line. Further, a color scheme or blinking scheme can be used for, among various features, identifying a source device, indicating whether a line is in use or not, representing a fluid to be provided by the line, etc.

Although a few implementations have been described in detail above, other modifications are possible. Other embodiments may be within the scope of the following claims. For instance, the implementations described herein can be used for wiring in electrical boxes, audio/visual systems, and other systems using a variety of wires or lines that tend to get twisted together.

1. An identification system comprising:
a source identifier and a destination identifier, each having a light, a control button for controlling the light, a transmitter for transmitting a control signal from the control button, and a transmission medium for conveying the transmitted control signal to the other of the source identifier or destination identifier.

2. The identification system in accordance with claim 1, wherein the light is a light emitting diode.

3. The identification system in accordance with claim 1, further comprising a power source for powering the light and the transmitter.

4. The identification system in accordance with claim 1, wherein the transmitter includes a radio frequency identifier tag, and wherein the transmission medium is a radio frequency wireless medium.

5. An identification method comprising:
attaching proximate to each end of a fluid line an identifier, each identifier having a light, a control button for controlling the light, a transmitter for transmitting a control signal from the control button, and a transmission medium for conveying the transmitted control signal from one identifier to the other identifier; and
controlling the button on one identifier to generate the control signal to activate an associated light; and
transmitting the control signal to activate a corresponding light on the other identifier.

6. The identification method in accordance with claim 5, wherein the lights are activated in parallel.
